(19) United States
(12) Patent Application Publication
(10) Pub. No.: US 2026/0254150 A1
(43) Pub. Date: Aug. 27, 2026

(54) MODULAR SNAP CONNECTOR AND SYSTEM

(71) Applicant: Lear Corporation, Southfield, MI (US)

(72) Inventors: Jun Roz Ruayana, Novi, MI (US); Vinodh Krishnan Balasubramanian, Sterling Heights, MI (US); William Bond, Livonia, MI (US); Erwin Baga-an, Cebu City (PH); Gaie Annah Marie Torrecampo Arzadon, Lapu-Lapu City (PH)

(21) Appl. No.: 19/548,200

(22) Filed: Feb. 24, 2026

Related U.S. Application Data
(60) Provisional application No. 63/764,311, filed on Feb. 27, 2025.

(51) Int. Cl. H01R 13/514

(52) U.S. Cl. CPC H01R 13/514

(57) ABSTRACT

A modular female snap connector includes one or more hook-shaped structures disposed at or about an upper surface and one or more slots disposed at or about the upper surface. Further, the modular female snap connector may include one or more wedge-shaped structures disposed at or about a lower surface, and one or more hook-shaped formations disposed at or about the lower surface. The one or more wedge-shaped structures may engage the one or more hook-shaped structures of a second modular female snap connector; and the one or more hook-shaped formations may engage the one or more slots of the second modular female snap connector. The modular female snap connector may be configured to be connected to the second modular female snap connector via a scoop and snap connection.

### CROSS-REFERENCE TO RELATED APPLICATION

This application claims priority to US Provisional Application No. 63/764,311, filed on February 27, 2025, the contents of which is hereby incorporated by reference in its entirety.

### TECHNICAL FIELD

The present disclosure generally relates to electrical connectors and associated assemblies or systems, including modular, stackable female electrical connectors configured to be joined using a scoop and snap process.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a front perspective view of an embodiment of a male connector according to teachings of the present disclosure.

FIG. 2 is a rear perspective view of an embodiment of a male connector according to teachings of the present disclosure.

FIG. 3 is a front perspective view of an embodiment of a female connector according to teachings of the present disclosure.

FIG. 4 is a bottom perspective view of an embodiment of a female connector according to teachings of the present disclosure.

FIG. 5 is an enlarged, detailed view of the region labeled A in FIG. 3, illustrating a wedge-shaped structure 22 according to teachings of the present disclosure.

FIG. 6 is an enlarged, detailed view of the region labeled B in FIG. 3, illustrating a hook-shaped structure according to teachings of the present disclosure.

FIG. 7 is an enlarged, detailed view of the region labeled C in FIG. 4, illustrating hook-shaped formations and slots according to teachings of the present disclosure.

FIG. 8 is a perspective view of an embodiment of stacked male and female connectors according to teachings of the present disclosure.

FIG. 9 is an exploded view of an embodiment of the stacked female connectors such as shown in FIG. 8, according to teachings of the present disclosure.

FIG. 10 is a perspective view of an embodiment of stacked female inline connectors according to teachings of the present disclosure.

FIG. 11 is an enlarged, detailed view of the regions labeled D in FIG. 10 according to teachings of the present disclosure.

FIG. 12 is a sectional view taken along line A-A of FIG. 10, generally illustrating a scoop connection according to teachings of the present disclosure.

FIG. 13 is a sectional view taken along line A-A of FIG. 10, generally illustrating a snap connection following a scoop connection generally shown in FIG. 12 according to teachings of the present disclosure.

FIG. 14 is an enlarged, detailed view of the region labeled E in FIG. 12, according to teachings of the present disclosure.

FIG. 15 is an enlarged, detailed view of the region labeled F in FIG. 13, according to teachings of the present disclosure.

FIG. 16 is an enlarged, detailed view of the region labeled F in FIG. 13, according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

Some conventional connector configurations and systems for stacking electrical female-to-female connectors can involve a large number of components or parts, such as casings, levers, covers, sub-connectors, intermediate brackets, and separate fastening hardware. Such configurations and systems may take up significant space and have a need for cavities with increased size requirements. Such configurations and systems may further not be suitable, or may be less suitable, for automation applications and/or package designs with limited space locations, such as vehicle doors, pillars, and interior compartments.

With conventional designs, stacking of electrical female-to-female connectors can be cumbersome, as it commonly requires many components, due to which automation of the stacking process can be very difficult. The need to handle, align, and assemble multiple separate pieces increases assembly time, cost, and the risk of assembly errors in high-volume manufacturing environments. Moreover, conventional stacked connector assemblies may not be well-suited for constrained vehicle package locations where space is at a premium.

The present disclosure generally relates to modular snap connectors and associated assemblies or systems.

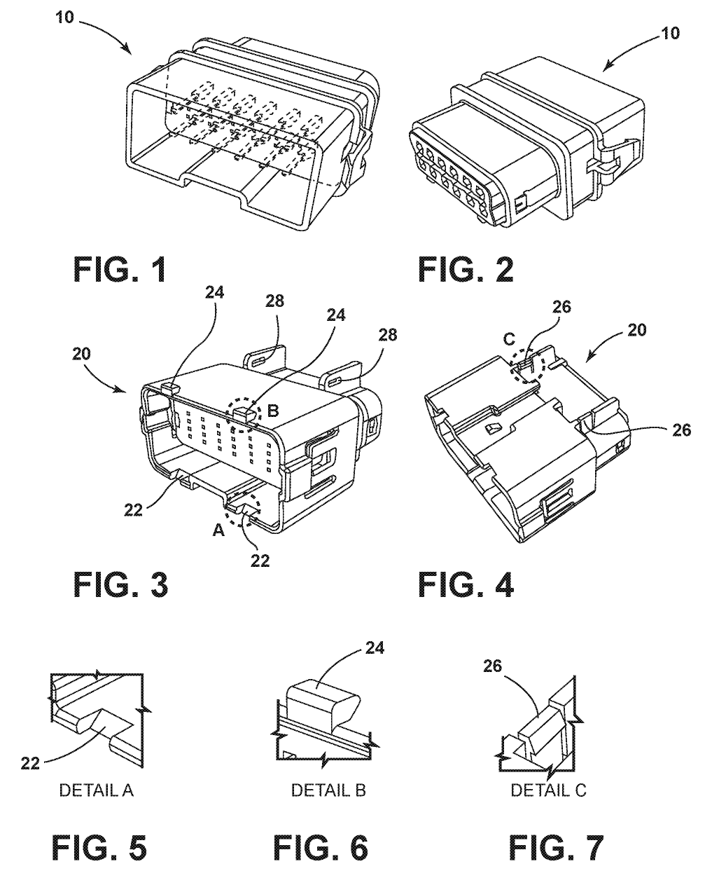

With embodiments, the modular connector assembly or system may be configured for connection with a male connector 10 as generally illustrated in FIGS. 1 and 2. The male connector 10 may include one or more male terminals/pins and/or a body or housing configured to mate with a corresponding female connector 20. In various embodiments, the male connector 10 may be part of an automotive wiring harness or module and is configured to be inserted into one or more cavities of the female connector 20 to establish electrical connections. Further, an embodiment of a female connector 20 is generally illustrated in FIGS. 3 and 4. The female connector 20 may comprise a connector body or housing that defines multiple cavities and/or receptacles configured to receive terminals and/or male connectors 10, as generally illustrated in FIG. 3. The female connector 20 may be configured to participate in a scoop and snap stacking process with one or more other female connectors 20.

To illustrate the principles of the present disclosure, an exemplary running embodiment of the female connector 20 is described herein with definitive characteristics. In this specific illustrated embodiment, the female connector 20 is a modular unit that has a connector body defining an upper surface and a lower surface. The female connector 20 has hook-shaped structures 24 and slots 28 disposed at or about the upper surface, and has wedge-shaped structures 22 and hook-shaped formations 26 disposed at or about the lower surface. Furthermore, in this running embodiment, the female connector 20 is formed as a single integrally molded plastic component, and the hook-shaped formations 26 are resilient elements configured to snap into the slots 28.

While the exemplary running embodiment described above possesses these specific structural characteristics, the scope of the present disclosure is not limited to this exact configuration. In various alternative embodiments, including those disclosed herein, the features of the female connector 20 may take different forms. For example, the female connector 20 may be constructed from multiple assembled components rather than a single integrally molded piece, and may utilize different materials such as composites, resins, or metals. Furthermore, the specific geometries, such as the hook-shaped formations 26, may be rigid rather than resilient, and the respective features may be inverted or rearranged on different surfaces of the connector body to achieve a similar scoop and snap connection.

With examples as shown in FIGS. 3 and 4, the female connector 20 may include one or more wedge‑shaped structures 22 disposed at or about a lower surface such as a bottom wall of the connector body or housing. The wedge‑shaped structures 22 may be formed as sharp wedge projections configured to engage corresponding hook‑shaped structures 24 of another female connector 20 during a scoop connection.

As also shown in FIGS. 3 and 4, the female connector 20 may include one or more hook‑shaped structures 24 disposed at or about an upper surface of the connector body or housing. The hook‑shaped structures 24 may be formed as ledges, hooks, and/or undercut features configured to receive and retain at least a portion of a corresponding wedge‑shaped structure 22 from another similar female connector 20. The female connector 20 may further include one or more hook‑shaped formations 26 disposed at or about a lower portion and/or lower surface of the connector body or housing and/or one or more slots 28 disposed at or about an upper portion or upper surface of the connector body or housing. As described in more detail with reference to FIG. 7, the hook‑shaped formations 26 and slots 28 cooperate to provide a snap connection between stacked female connectors 20.

FIG. 5, which provides an enlarged detail view of the region labeled A in FIG. 3, generally illustrates an example of a wedge‑shaped structure 22. In some embodiments, the wedge‑shaped structure 22 may comprise a sharply tapered projection extending from the lower surface of the female connector 20, with a geometry selected to facilitate insertion or scooping into a corresponding hook‑shaped structure 24. The wedge‑shaped structure 22 may be oriented such that, as one female connector 20 is moved relative to another, the wedge‑shaped structure 22 slides into and is supported by the hook‑shaped structure 24 during the scoop step.

Further, FIG. 6, which provides an enlarged detail view of the region labeled B in FIG. 3, generally illustrates an example of a hook-shaped structure 24. In embodiments, the hook-shaped structure 24 may be formed as a ledge, shoulder, and/or hook extending from the upper surface of the female connector 20 and may define a recess or undercut configured to receive the wedge-shaped structure 22 from another female connector 20. The shape and/or angle of the hook-shaped structure 24 may be selected to guide the wedge-shaped structure 22 during the scoop movement and to support stacked connectors under load.

Additional embodiments are shown in FIG. 7, which provides an enlarged detail view of the region labeled C in FIG. 4, generally illustrating examples of hook‑shaped formations 26 and slots 28. In some embodiments, the hook‑shaped formations 26 extend generally in a direction from the upper surface toward the lower surface of the female connector 20 and may be resilient elements configured to deflect during engagement with the slots 28 and to bias into the slots 28 once engaged. The slots 28 may be formed in protrusions extending from a region at or about the upper surface of the female connector 20, such as walls and/or flanges that project upward from the connector body or housing. The slots 28 may be generally spaced on opposing sides of the female connector 20 and may be positioned to receive respective hook-shaped formations 26 of another female connector 20. The slots 28 may have any suitable size or shape to match a size or shape of the hook-shaped formations 26, thereby providing secure mechanical retention when the formations 26 snap into the slots 28.

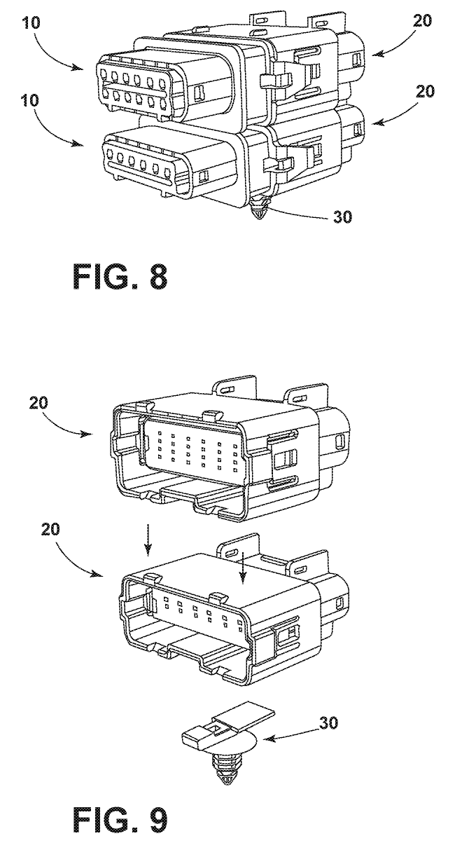

FIGS. 8 and 9 generally illustrate an embodiment of stacked male and female connectors 10, 20. In some embodiments, one or more male connectors 10 are inserted into respective female connectors 20, which are themselves stacked via the wedge‑shaped structures 22, hook‑shaped structures 24, hook‑shaped formations 26, and slots 28 as described herein. A fastener or connecting means 30 may be associated with the stacked female connectors 20, for example to provide additional retention or to interface the stacked connector assembly with a mounting structure. The fastener 30 may include any variety of shape, sizes, and/or configuration.

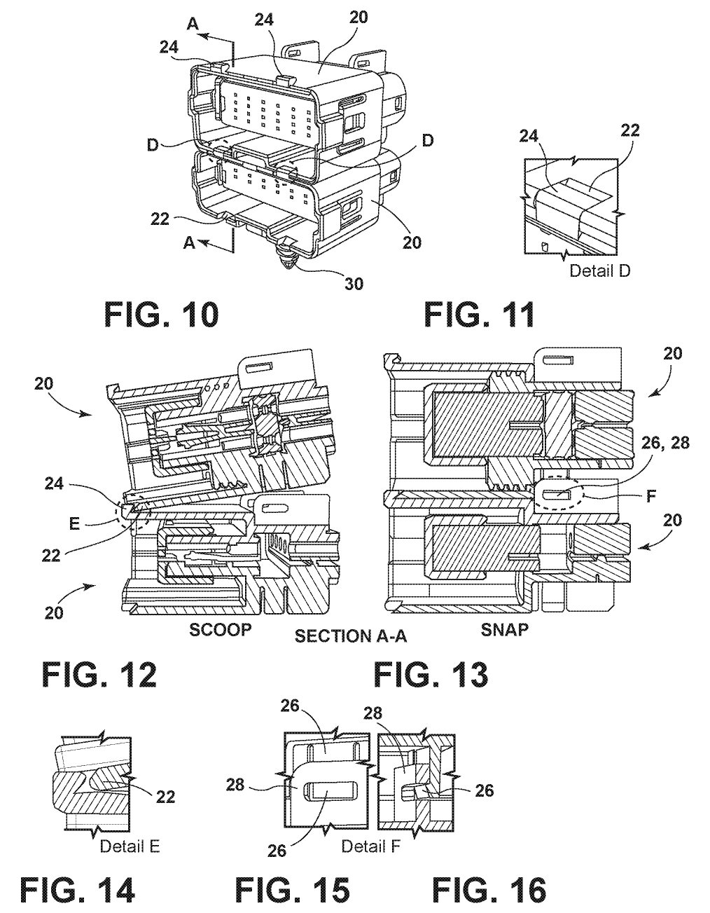

An embodiment of stacked female connectors 20, depicted inline, is generally illustrated in FIG. 10. In such an embodiment, multiple female connectors 20 may be stacked along a longitudinal axis to create an inline stacked connector assembly. Each female connector 20 in the inline stack may include the wedge‑shaped structures 22 at or about a lower surface thereof, the hook‑shaped structures 24 and slots 28 at or about an upper surface, and the hook‑shaped formations 26 at or about the lower surface.

FIG. 11 generally illustrates an enlarged, detailed view of the region labeled D in FIG. 10. Detail D may illustrate how the wedge‑shaped structures 22 of an upper female connector 20 are positioned relative to the hook‑shaped structures 24 of a lower female connector 20, and how the hook‑shaped formations 26 of the upper connector are aligned with the slots 28 of the lower connector in preparation for or following a scoop and snap assembly. In assembly, the hook-shaped structures 24 may be partially or entirely inserted into the wedge-shaped structures 22.

FIG. 12 is a sectional view taken along line A‑A of FIG. 10, generally illustrating a scoop connection between stacked female connectors 20. In embodiments, to initiate stacking, a first female connector 20 is moved relative to a second female connector 20 such that one or more wedge‑shaped structures 22 of the first female connector 20 are inserted into the one or more hook‑shaped structures 24 of the second female connector 20. This step of the connection process may comprise a scoop operation.

FIG. 13 is a sectional view taken along line A-A of FIG. 10, generally illustrating a snap connection following the scoop connection shown in FIG. 12. After the wedge-shaped structures 22 of the first female connector 20 have been inserted into the hook-shaped structures 24 of the second female connector 20, the first female connector 20 may be moved further (for example downwardly) so that the hook-shaped formations 26 of the first female connector 20 approach the slots 28 of the second female connector 20. During this movement, the hook-shaped formations 26 may be deflected by contact with portions of the protrusions or flanges that define the slots 28 until the formations 26 reach the openings of the slots 28 and snap into place. The formations 26 may be resilient elements configured to bias into the slots 28, thereby providing a secure snap connection between the stacked connectors 20.

FIG. 15 is an enlarged, detailed view of the region labeled F in FIG. 13, and FIG. 16 provides a further enlarged or alternative detail of the same region. Detail F may show at least a portion of each hook-shaped formation 26 extending into or through a corresponding slot 28, with the surrounding protrusion or flange material providing retention surfaces that resist separation of the stacked connectors 20 under normal operating loads. The cooperation of the wedge-shaped structures 22 and hook-shaped structures 24 (e.g., scoop) and the hook-shaped formations 26 and slots 28 (e.g., snap) defines a scoop and snap assembly that can be repeated to stack multiple female connectors 20 together.

With examples, a configuration of two stacked female connectors 20 is generally illustrated in FIG. 10, and the connection or stacking process can be as generally described above with respect to FIGS. 12-16. Such a connection or stacking process can be automated in manufacturing facilities; further, automated handling equipment may grip a first female connector 20, align it relative to a second female connector 20 so that wedge-shaped structures 22 align with hook-shaped structures 24 and hook-shaped formations 26 align with slots 28, and then perform the scoop and snap movements in a programmed sequence. Male connectors 10, such as shown in FIGS. 1 and 2, may be connected or inserted into corresponding female connectors 20 through multiple cavities provided on the female connectors 20, such as those shown in FIG. 3. In this manner, stacked female connectors 20 can provide multiple connection points in a compact volume, enabling a more efficient and streamlined vehicle component assembly process.

Moreover, assemblies as disclosed herein may be used in applications with space constraints, such as in vehicle compartments or doors, pillars, and other constrained regions. By integrating the scoop and snap stacking features (wedge-shaped structures 22, hook-shaped structures 24, hook-shaped formations 26, and slots 28) into a single-component female connector 20, the overall part count can be reduced, and packaging efficiency in such constrained locations can be improved.

With some embodiments, the described features may be reversed, for example, provided on respectively opposite sides or surfaces of similar female connectors 20. For example and without limitation, the one or more wedge-shaped structures 22 could instead be provided on or about an upper surface of one female connector 20, with corresponding one or more hook-shaped structures 24 being provided on or about a bottom or lower surface of another similar female connector 20. Similarly, one or more hook-shaped formations 26 and the one or more corresponding slots 28 may be reversed with respect to a pair of stacked female connectors 20.

In various embodiments, the present disclosure also encompasses methods of assembling stacked connector assemblies or systems using the modular female snap connectors described herein. In examples, a first modular female snap connector 20 and a second modular female snap connector 20 may be provided, each comprising one or more hook‑shaped structures 24 disposed at or about an upper surface, one or more slots 28 disposed at or about the upper surface, one or more wedge‑shaped structures 22 disposed at or about a lower surface, and one or more hook‑shaped formations 26 disposed at or about the lower surface. The method may include inserting the one or more wedge‑shaped structures 22 of the first modular female snap connector 20 into the one or more hook‑shaped structures 24 of the second modular female snap connector 20 to form a scoop connection, and moving the first modular female snap connector 20 relative to the second modular female snap connector 20 to engage the one or more hook‑shaped formations 26 of the first modular female snap connector 20 with the one or more slots 28 of the second modular female snap connector 20 to form a snap connection. The hook‑shaped formations 26 may comprise resilient elements that are biased into the slots 28 during the moving step, and the slots 28 may be disposed on flanges or protrusions extending from at or about the upper surface and generally spaced on opposing sides of each connector 20. In some embodiments, the method may further include repeating the scoop and snap operations for additional modular female snap connectors 20 to form a stack of three or more connectors, orienting the connectors so that the respective wedge‑shaped structures 22, hook‑shaped structures 24, hook‑shaped formations 26, and slots 28 are aligned prior to insertion, and performing some or all of the inserting and moving steps using automated assembly equipment in a manufacturing facility.

The disclosure includes, without limitation, the following embodiments:
1. A modular female snap connector, comprising: a connector body having an upper surface and a lower surface; one or more hook-shaped structures disposed at or about the upper surface; one or more slots disposed at or about the upper surface; one or more wedge-shaped structures disposed at or about the lower surface; and one or more hook-shaped formations disposed at or about the lower surface; wherein the modular female snap connector is configured to couple with a second modular female snap connector such that: the one or more wedge-shaped structures are configured to engage corresponding hook-shaped structures of the second modular female snap connector; and the one or more hook-shaped formations are configured to engage corresponding slots of the second modular female snap connector.
2. The modular female snap connector, according to embodiment 1, wherein the modular female snap connector is configured to be connected to the second modular female snap connector via a scoop and snap connection.
3. The modular female snap connector, according to any of the preceding embodiments, wherein the modular female snap connector is configured such that, during the scoop and snap connection, the one or more wedge-shaped structures of the modular female snap connector engage the one or more hook-shaped structures of the second modular female snap connector to form a scoop connection; and the one or more hook-shaped formations of the modular female snap connector engage the one or more slots of the second modular female snap connector to form a snap connection.
4. The modular female snap connector, according to any of the preceding embodiments, wherein the modular female snap connector is formed as a single integrally molded component comprising the connector body, the one or more wedge-shaped structures, the one or more hook‑shaped structures, and the one or more hook‑shaped formations.
5. The modular female snap connector, according to any of the preceding embodiments, wherein the modular female snap connector is configured such that the modular female snap connector and the second modular female snap connector can be stacked together in an inline configuration by repeated scoop and snap connections.
6. The modular female snap connector, according to any of the preceding embodiments, wherein the one or more hook-shaped formations comprise resilient elements configured to bias the one or more hook-shaped formations into the one or more slots of the second female snap connector.
7. The modular female snap connector, according to any of the preceding embodiments, further comprising one or more cavities configured to receive one or more male terminals.
8. The modular female snap connector, according to any of the preceding embodiments, wherein the one or more hook-shaped formations extend in a direction from the upper surface to the lower surface.
9. The modular female snap connector, according to any of the preceding embodiments, wherein the one or more slots are generally spaced on opposing sides of the modular female snap connector; and the one or more slots are provided on walls or flanges that extend from at or about the upper surface.
10. A stacked connector assembly, comprising: a plurality of modular female snap connectors, each female snap connector comprising: a connector body having an upper surface and a lower surface; one or more hook-shaped structures disposed at or about the upper surface; one or more slots disposed at or about the upper surface; one or more wedge-shaped structures disposed at or about the lower surface; and one or more hook-shaped formations disposed at or about the lower surface; wherein the plurality of modular female snap connectors includes at least a first modular female snap connector and a second modular female snap connector stacked together such that: the one or more wedge-shaped structures of the first modular female snap connector engage the one or more hook-shaped structures of the second modular female snap connector; and the one or more hook-shaped formations of the first modular female snap connector engage the one or more slots of the second modular female snap connector.
11. The stacked connector assembly according to embodiment 10, wherein the plurality of modular female snap connectors are stacked together in an inline configuration by repeated scoop and snap assemblies.
12. The stacked connector assembly according to any of the preceding embodiments, wherein each modular female snap connector of the plurality is formed as a single integrally molded component comprising the one or more hook-shaped structures, the one or more slots, the one or more wedge-shaped structures, and the one or more hook-shaped formations.
13. The stacked connector assembly according to any of the preceding embodiments, wherein the one or more hook-shaped formations of each modular female snap connector comprise resilient elements configured to bias the one or more hook-shaped formations into the one or more slots of an adjacent one of the plurality of modular female snap connectors when stacked.
14. The stacked connector assembly according to any of the preceding embodiments, wherein the one or more slots of each modular female snap connector are generally spaced on opposing sides of the respective modular female snap connector and are provided on walls or flanges that extend from at or about the upper surface.
15. The stacked connector assembly according to any of the preceding embodiments, wherein the stacked connector assembly is configured as a pre-assembled unit for installation in a vehicle.
16. A method of assembling a stacked connector assembly, comprising: providing a first modular female snap connector comprising a first connector body having a first upper surface and a first lower surface, one or more hook-shaped structures disposed at or about the first upper surface, one or more slots disposed at or about the first upper surface, one or more wedge-shaped structures disposed at or about the first lower surface, and one or more hook-shaped formations disposed at or about the first lower surface; providing a second modular female snap connector comprising a second connector body having a second upper surface and a second lower surface, one or more corresponding hook-shaped structures disposed at or about the second upper surface, one or more corresponding slots disposed at or about the second upper surface, one or more corresponding wedge-shaped structures disposed at or about the second lower surface, and one or more corresponding hook-shaped formations disposed at or about the second lower surface; inserting the one or more wedge-shaped structures of the first modular female snap connector into the one or more corresponding hook-shaped structures of the second modular female snap connector to form a scoop connection; and moving the first modular female snap connector relative to the second modular female snap connector to engage the one or more hook-shaped formations of the first modular female snap connector with the one or more slots of the second modular female snap connector to form a snap connection.
17. The method according to any of the preceding embodiments, wherein the one or more hook-shaped formations of the first modular female snap connector comprise resilient elements; and the moving the first modular female snap connector relative to the second modular female snap connector biases the one or more hook-shaped formations into the one or more slots of the second modular female snap connector.
18. The method according to any of the preceding embodiments, wherein the one or more slots are disposed on one or more walls or flanges that extend from at or about the second upper surface.
19. The method according to any of the preceding embodiments, wherein the one or more corresponding slots are generally spaced on opposing sides of the second modular female snap connector, the method further comprising: orienting the first and second modular female snap connectors relative to one another prior to performing the inserting and the moving.
20. The method according to any of the preceding embodiments, wherein orienting the first and second modular female snap connectors further comprises: aligning the one or more wedge-shaped structures of the first modular female snap connector with the one or more hook-shaped structures of the second modular female snap connector; and aligning the one or more hook-shaped formations of the first modular female snap connector with the one or more slots of the second modular female snap connector prior to performing the inserting and the moving.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader’s understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, assemblies, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A modular female snap connector, comprising:
a connector body having an upper surface and a lower surface;
one or more hook-shaped structures disposed at or about the upper surface;
one or more slots disposed at or about the upper surface;
one or more wedge-shaped structures disposed at or about the lower surface; and
one or more hook-shaped formations disposed at or about the lower surface;
wherein the modular female snap connector is configured to couple with a second modular female snap connector such that:
the one or more wedge-shaped structures are configured to engage corresponding hook-shaped structures of the second modular female snap connector; and
the one or more hook-shaped formations are configured to engage corresponding slots of the second modular female snap connector.

2. The modular female snap connector of claim 1, wherein the modular female snap connector is configured to be connected to the second modular female snap connector via a scoop and snap connection.

3. The modular female snap connector of claim 2, wherein the modular female snap connector is configured such that, during the scoop and snap connection, the one or more wedge-shaped structures of the modular female snap connector engage the one or more hook-shaped structures of the second modular female snap connector to form a scoop connection; and the one or more hook-shaped formations of the modular female snap connector engage the one or more slots of the second modular female snap connector to form a snap connection.

4. The modular female snap connector of claim 1, wherein the modular female snap connector is formed as a single integrally molded component comprising the connector body, the one or more wedge-shaped structures, the one or more slots, the one or more hook‑shaped structures, and the one or more hook‑shaped formations.

5. The modular female snap connector of claim 1, wherein the modular female snap connector is configured such that the modular female snap connector and the second modular female snap connector can be stacked together in an inline configuration by repeated scoop and snap connections.

6. The modular female snap connector of claim 1, wherein the one or more hook-shaped formations comprise resilient elements configured to bias the one or more hook-shaped formations into the corresponding one or more slots of the second modular female snap connector.

7. The modular female snap connector of claim 1, further comprising one or more cavities configured to receive one or more male terminals.

8. The modular female snap connector of claim 1, wherein the one or more hook-shaped formations extend in a direction from the upper surface to the lower surface.

9. The modular female snap connector of claim 1, wherein the one or more slots are generally spaced on opposing sides of the modular female snap connector; and the one or more slots are provided on walls or flanges that extend from at or about the upper surface.

10. A stacked connector assembly, comprising:
a plurality of modular female snap connectors, each female snap connector comprising:
a connector body having an upper surface and a lower surface;
one or more hook-shaped structures disposed at or about the upper surface;
one or more slots disposed at or about the upper surface;
one or more wedge-shaped structures disposed at or about the lower surface; and
one or more hook-shaped formations disposed at or about the lower surface;
wherein the plurality of modular female snap connectors includes at least a first modular female snap connector and a second modular female snap connector stacked together such that:
the one or more wedge-shaped structures of the first modular female snap connector engage the one or more hook-shaped structures of the second modular female snap connector; and
the one or more hook-shaped formations of the first modular female snap connector engage the one or more slots of the second modular female snap connector.

11. The stacked connector assembly of claim 10, wherein the plurality of modular female snap connectors are stacked together in an inline configuration by repeated scoop and snap assemblies.

12. The stacked connector assembly of claim 10, wherein each modular female snap connector of the plurality is formed as a single integrally molded component comprising the connector body, the one or more hook-shaped structures, the one or more slots, the one or more wedge-shaped structures, and the one or more hook-shaped formations.

13. The stacked connector assembly of claim 10, wherein the one or more hook-shaped formations of each modular female snap connector comprise resilient elements configured to bias the one or more hook-shaped formations into the one or more slots of an adjacent one of the plurality of modular female snap connectors when stacked.

14. The stacked connector assembly of claim 10, wherein the one or more slots of each modular female snap connector are generally spaced on opposing sides of the respective modular female snap connector and are provided on walls or flanges that extend from at or about the upper surface.

15. The stacked connector assembly of claim 10, wherein the stacked connector assembly is configured as a pre-assembled unit for installation in a vehicle.

16. A method of assembling a stacked connector assembly, comprising:
providing a first modular female snap connector comprising a first connector body having a first upper surface and a first lower surface, one or more hook-shaped structures disposed at or about the first upper surface, one or more slots disposed at or about the first upper surface, one or more wedge-shaped structures disposed at or about the first lower surface, and one or more hook-shaped formations disposed at or about the first lower surface;
providing a second modular female snap connector comprising a second connector body having a second upper surface and a second lower surface, one or more corresponding hook-shaped structures disposed at or about the second upper surface, one or more corresponding slots disposed at or about the second upper surface, one or more corresponding wedge-shaped structures disposed at or about the second lower surface, and one or more corresponding hook-shaped formations disposed at or about the second lower surface;
inserting the one or more wedge-shaped structures of the first modular female snap connector into the one or more corresponding hook-shaped structures of the second modular female snap connector to form a scoop connection; and
moving the first modular female snap connector relative to the second modular female snap connector to engage the one or more hook-shaped formations of the first modular female snap connector with the one or more slots of the second modular female snap connector to form a snap connection.

17. The method of claim 16, wherein the one or more hook-shaped formations of the first modular female snap connector comprise resilient elements; and the moving the first modular female snap connector relative to the second modular female snap connector biases the one or more hook-shaped formations into the one or more slots of the second modular female snap connector.

18. The method of claim 17, wherein the one or more slots are disposed on one or more walls or flanges that extend from at or about the second upper surface.

19. The method of claim 18, wherein the one or more corresponding slots are generally spaced on opposing sides of the second modular female snap connector, the method further comprising:
orienting the first and second modular female snap connectors relative to one another prior to performing the inserting and the moving.

20. The method of claim 19, wherein orienting the first and second modular female snap connectors further comprises:
aligning the one or more wedge-shaped structures of the first modular female snap connector with the one or more hook-shaped structures of the second modular female snap connector; and aligning the one or more hook-shaped formations of the first modular female snap connector with the one or more slots of the second modular female snap connector prior to performing the inserting and the moving.
